(19) United States
(12) Patent Application Publication
(10) Pub. No.: US 2024/0362232 A1
(43) Pub. Date: Oct. 31, 2024

(54) DYNAMIC DATASET GENERATION SYSTEM

(71) Applicant: Signal4D, Inc., Seattle, WA (US)

(72) Inventors: David Low Weld, Seattle, WA (US); Dmitry Kaplan, Bellevue, MA (US)

(21) Appl. No.: 18/140,772

(22) Filed: Apr. 28, 2023

(51) Int. Cl. G06F 16/2455; G06F 16/2453; G06F 16/248; G08B 21/18

(52) U.S. Cl. CPC G06F 16/24568; G06F 16/24542; G06F 16/248; G08B 21/18

(57) ABSTRACT

Provided are systems and methods for generating a resultant dynamic dataset are provided. The method comprises receiving a first data stream of a first data layer associated with locations included as part of an external environment, receiving a second data stream of a second data layer, generating a first dynamic dataset from the first data stream as corresponding to the locations and a second dynamic dataset from the second data stream as corresponding to the locations, generating an output corresponding to a resultant dynamic dataset that is based on the first dynamic dataset and the second dynamic dataset, the generating of the output including associating at least one value from the first dynamic dataset and at least one value from the second dynamic dataset with at least one of the locations, and providing the output corresponding to the resultant dynamic dataset, the providing including displaying, storing, processing, and/or transmitting.

### BACKGROUND

Conventional geotemporal data aggregation and analysis techniques sometimes enable streaming of information from various sources. These technologies may not combine these streams of information or data in particular ways.

### SUMMARY

In an aspect, a method for generating a resultant dynamic dataset from a plurality of dynamic datasets associated with various data sources is provided. The method including receiving a first data stream of a first data layer associated with a plurality of locations included as part of an external environment, receiving a second data stream of a second data layer, generating a first dynamic dataset from the first data stream as corresponding to the plurality of locations and a second dynamic dataset from the second data stream as corresponding to the plurality of locations, generating an output corresponding to a resultant dynamic dataset that is based on the first dynamic dataset and the second dynamic dataset, the generating of the output including associating at least one value from the first dynamic dataset and at least one value from the second dynamic dataset with at least one of the plurality of locations, and providing the output corresponding to the resultant dynamic dataset, the providing including at least one of displaying, storing, further processing, and/or transmitting.

In another aspect, a system for generating a resultant dynamic dataset from a plurality of dynamic datasets associated with various sources is provided. The system including at least one data processor, a display coupled to the at least one data processor, and memory storing instructions which, when executed, cause the at least one data processor to perform operations comprising: receiving a first data stream of a first data layer associated with a plurality of locations included as part of an external environment, receiving a second data stream of a second data layer; generating a first dynamic dataset from the first data stream as corresponding to the plurality of locations and a second dynamic dataset from the second data stream as corresponding to the plurality of locations; generating a graphical representation, the generating including associating at least one value from the first dynamic dataset and at least one value from the second dynamic dataset with at least one of the plurality of locations; and outputting, in real time, the graphical representation on a display coupled to the at least one data processor.

### BRIEF DESCRIPTION OF THE FIGURES

FIG. 1 depicts an example environment that includes a main server that receives data from various sources and generates a resultant dataset, according to one or more aspects described and illustrated herein;

FIG. 2A depicts an example graphical representation of a user interface associated with the software application of the system of the present disclosure, according to one or more aspects described and illustrated herein;

FIG. 2B depicts an example graphical representation in which an additional resultant dynamic data layer is included as part of the example graphical representation, according to one or more aspects described and illustrated herein;

FIG. 3A depicts an example interactive digital map that includes a plurality of store locations across a geographical area and an example resultant dynamic dataset upon which a temperature graphic (e.g., an example result dynamic data layer) is output on a portion of the interactive digital map, according to one or more aspects described and illustrated herein;

FIG. 3B depicts an example interactive digital map that includes a plurality of store locations across a geographical area and an additional example resultant dynamic dataset upon which an example graphic is generated (e.g., an example result dynamic data layer) may be output on a portion of the interactive digital map, according to one or more aspects described and illustrated herein;

FIG. 3C depicts a vehicle travel route connecting two store locations, according to one or more aspects described and illustrated herein;

FIG. 4 depicts an example pop-up window that is displayed upon a selection of a store location icon, according to one or more aspects described and illustrated herein; and

FIG. 5 depicts a flow chart for generating and providing a resultant dynamic dataset, according to one or more aspects described and illustrated herein; and

FIG. 6 depicts the main server that may implement the resultant dynamic dataset generation system as described in the present disclosure, according to some aspects described and illustrated herein.

### DETAILED DESCRIPTION

In the following description numerous specific details are set forth in order to provide a thorough understanding of the present disclosure for the purposes of explanation. It will be apparent, however, that the aspects described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all aspects or that the features represented by such element may not be included in or combined with other elements in some aspects unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as is needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described aspects. The first contact and the second contact are both contacts, but they are not the same contact.

The terminology used in the description of the various described aspects herein is included for the purpose of describing particular aspects only and is not intended to be limiting. As used in the description of the various described aspects and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units are in communication with each other even though the information transmitted is modified, processed, relayed, and/or routed between the first and second unit. For example, a first unit is in communication with a second unit even though the first unit passively receives information and does not actively transmit information to the second unit. As another example, a first unit is in communication with a second unit if at least one intermediary unit (e.g., a third unit located between the first unit and the second unit) processes information received from the first unit and transmits the processed information to the second unit. In some aspects, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to aspects, examples of which are illustrated in the accompanying drawings. In the following detailed description, numerous specific details are set forth in order to provide a thorough understanding of the various described aspects. However, it will be apparent to one of ordinary skill in the art that the various described aspects can be practiced without these specific details. In other instances, well-known methods, procedures, components, circuits, and networks have not been described in detail so as not to unnecessarily obscure aspects of the aspects.

As stated above, conventional data aggregation and analysis techniques may enable streaming of information from various sources. These technologies fail, however, to combine these streams of information or data in particular ways.

The system as described in the present disclosure addresses and overcomes these deficiencies. In particular, the system aggregates data from a variety of data sources, analyzes the data in real time, generates resultant datasets, communicates data alerts (e.g., text message, audio visual messages, etc.) to one or more external devices, and provides the resultant datasets to various parties in a consumable format or manner. For example, the consumable format may be in the form of an email, a text message, or as digital overlays that may be positioned onto various digital base mas. Aspects of the system may also include a software platform including one or more software applications that receives data streams, e.g., temperature/weather data, traffic data, data related to the likelihood of fire zones within a particular area, and so forth, from private and governmental sources. These software applications analyze the temperature/weather data, traffic data, fire zones data, etc., in correlation with or in association with particular client or customer provided criteria such as, e.g., a vehicle route, a flight route, a bus route, a drone route, a shipping route, a physical location of stores spread across a geographic area (e.g., a city, a state, a country, etc.), e.g., latitudes and longitudes corresponding to the physical store locations.

In aspects, the software platform generates a digital map subsequent to analyzing temperature/weather data (e.g., a first data layer), traffic data (e.g., a second data layer), and fire zones data (e.g., a third data layer) such that the digital map includes graphical representations (e.g., interactive icons and/or shapes) representative of each of these data layers. Data layers may include other data streams, e.g., streams associated with flight route data, shipping routes data, power line locations data, railway line locations data, and so forth. In aspects, other data layers may be based on geographic boundaries and have features that are based on federal, state, country, city, and other such governmental entities. Additionally, data layers may also be based on altitudes, aspects of water bodies, land, tree covers, types of soil, and so forth. Data layers may also cover population densities, age distributions, incomes, marketing and sales areas, distances to various stores, information regarding inventory of goods, and so forth. In aspects, the data from the various data streams that is analyzed may be digitally packaged and communicated in a manner that enables or facilitates integration of the data with other software applications and/or user interfaces of various customers. For example, as stated above, resultant data layers may be generated from the data streams and packaged in particular ways. For example, a proprietary software application or platform of a company (e.g., a retail supplies) may receive the analyzed data streams (e.g., from the software platform operating on one of more of the servers of the client) and utilize this data to generate and output a digital map on a user interface that is proprietary to the retail supplier. In other examples, another company may be provided access to an interactive digital map that is generated by the software platform of the client. The communication of data from the software platform to one or more client devices may occur in real time. The data communicated to one or more customers or clients by the platform of the client may also be updated and/or modified in real time to reflect real time changes in weather and temperature conditions, traffic conditions, fire zone conditions, and so forth. Additionally, alerts in the form of text messages and audio visual content may be communicated, automatically and without user intervention, to various devices, e.g., associated with customers or subscribers.

Some of the advantages of the system include providing reliable, granular, and accurate temperature data, weather data, fire zones data, traffic data, and so forth, on a real time basis to a variety to client devices, e.g., in order to enable the client to efficiently perform critical tasks and monitor business operations. For example, the client may receive, on one or more client devices, data on a real time basis in association with, e.g., a vehicle route, flight routes, shipping route, power lines, one or more physical locations, and so forth. Such data may be associated with separate and distinct data layers that are simultaneously displayed in an interactive digital report or as part of an interactive digital map based on criteria provided by the customer. For example, the digital report or interactive digital map may monitor temperature and traffic variations along a trucking route from a source to a destination location and send an alert to one or more client devices if, e.g., temperatures at one or more points along the route exceed a particular condition. Such alerts may facilitate clients to take precautionary actions, e.g., alter the truck route, send messages to truck drivers informing them to halt, and so forth. Further, the digital reports and maps may be updated in real time to reflect changes in weather conditions, temperatures conditions related to customer provided criteria such as vehicles routes, flight routes, fire zones, power line locations, etc.

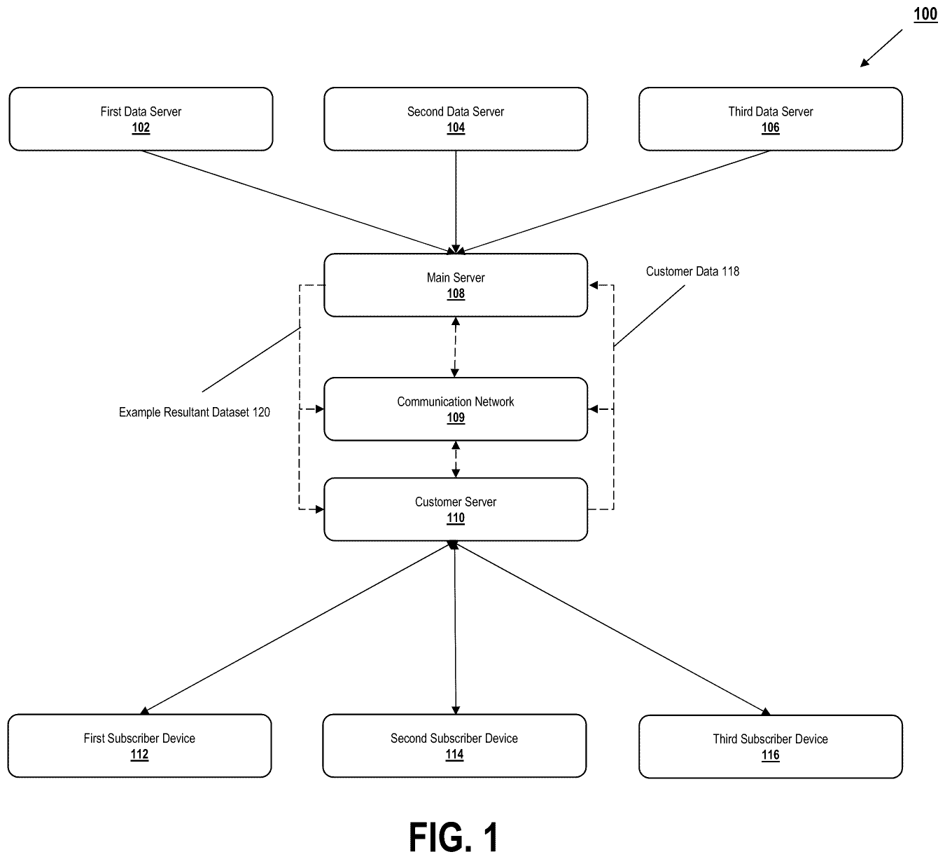

FIG. 1 depicts an example environment 100 that includes a main server 108 that receives data from various sources and generates a resultant dataset, according to one or more aspects described and illustrated herein. In particular, as illustrated in FIG. 1, the main server 108 of the example environment 100 receives data from a plurality of sources such as various servers associated with private companies that collect weather data, governmental departments that collect data regarding traffic flows and accidents, private companies that collect information about traffic flows and accidents, corporations and governmental departments that collect data regarding wildfires, air quality, flight travel patterns, flight restriction zones, and so forth. In aspects, the sources can also include servers of private and/or governmental companies that collect data associated with governmental boundaries, national rail networks, national power grids, and various local and interstate road networks, and so forth. It is noted that the various servers described in this disclosure could be cloud servers, physical servers, and other such comparable servers.

In aspects, the sources can also collect information representative of financial performance of a particular store of a particular company, accidents or claim rates associated with a particular store of company, and so forth. It is noted that the above sources are non-limiting examples. In aspects, the data collected and stored by these sources can include data associated with, e.g., motor vehicle accidents and various vehicle and individual related incidents, movement citations, department of transportation related fines, and so forth. In aspects, the data collected and stored by these sources can also include information related to product spoilage, e.g., time that it takes for various types of produce to spoil, the temperature at which produce may spoil, retail sales based on weather, location, and promotional budgets, consumer travel choices based on seasonality and weather, road accident clustering and severity based on vehicle type, age of driver and weather, and so forth. In aspects, the weather may also impact future traffic speeds.

In aspects, the collected data can also include estimated travel times for vehicles carrying various types of cargo, e.g., trucks, trains, and other vehicles that are dedicated for transporting goods, fuel consumption data, vehicle maintenance related data, and so forth. In aspects, data related to processes that need to be implemented to maintain vehicles in accordance with a particular condition can be collected and stored in these sources. In aspects, these sources can also store data specific to the performance of various stores, chains, industrial facilities, and so forth.

In aspects, the main server 108 can collect data, substantially in real time, from one or more of these sources, transform the data into one or more formats, implement various processes on the data, and generate various additional datasets (e.g., resultant dynamic datasets) based on particular customer requirements and preferences.

Thereafter, in aspects, the main server 108 can share the generated dynamic dataset, substantially in real time, with various components that are external to the main server 108. For example, as illustrated in FIG. 1, the main server 108 can communicate the generated dynamic dataset to a client server 110, which in turn can provide access to the generated dynamic dataset or transmit the generated dataset to various devices that are external to the client server 110.

In one example, the dynamic dataset generation system described in the present disclosure can include one or more software applications that collect data specific to the industry of a particular client and generate a resultant dynamic dataset that is specific to the requirements and preferences of the client. In aspects, the clients can purchase one or more subscriptions that provide access to the software applications of the system. For example, a client can be a large grocery chain that purchases a subscription for the purpose of tracking and monitoring routes of vehicles operated by one or more transportation companies to ensure that the produce purchased by a particular store of the grocery chain does not spoil in transit. In this example, the grocery chain may access the software application of the system that operates simultaneously in the client server 110 and the main server 108. In aspects, the software application may obtain data from one or more of the first data source server 102, the second data source server 104, and the third data source server 106. The first data source server 102 may correspond to a server of a weather company, while the second and third cloud server 104 and 106 may correspond to transportation data, road networks data, fire zones data, and so forth.

In operation, the client server 110 may utilize the software application of the dynamic dataset generation system to track a travel route of one or more trucks that are transporting produce (e.g., tomatoes, potatoes, and other vegetables) from a source location to a destination location. Along such a route, the main server 108 may collect temperature data, traffic incidents data, data related to likelihood of fire, and so forth, and generate a resultant dynamic dataset. Thereafter, the main server 108 may communicate the resultant dynamic dataset or provide access to the client server 110 of the resultant dynamic dataset, which in turn may provide access to the data to each of the first subscriber device 112, the second subscriber device 114, and the third subscriber device 116.

In this example, the software application may determine that the likelihood of the produce spoiling may increase in a particular portion of the route due to, e.g., a heat wave that may cause a sudden temperature rise, a snow storm that may result in a sudden decrease in temperature, and so forth. As such, the main server 108 may provide access to such information to client server 110 (e.g., through a software portal, an automatic alert, and so forth), in addition to suggesting an alternate route to the client server 110. The alternative route may at least partially prevent spoliation of produce. In other aspects, alternative routes may be suggested to the client server 110 to assist the transport vehicles to avoid fire zones, traffic jams, and so forth. These actions may also prevent spoliation of produce. In the produce transportation example described above, the first subscriber device 112, the second subscriber device 114, and the third subscriber device 116 may correspond to computing devices that are included as part of the vehicles that transport the produce. The client server 110 may operate to communicate wirelessly with each of the first subscriber device 112, the second subscriber device 114, and the third subscriber device 116. In other examples, a trucking company may subscribe primarily to or primarily access temperature data and wind data, and communicate this data, substantially in real time, at various fixed time intervals, or at various time periods to various other devices. These devices, operating conjunction with various components in the trucks of the trucking company, or operating individually, may generate notifications or alerts indicating that the cargo (e.g., fish) in these trucks may be adversely affected if, e.g., the temperature within the truck exceeds a threshold value, such as 100 degrees. In other examples, if the wind data indicates that the winds are above a particular threshold, e.g., 40 miles per hour, a warning may be generated that indicates that there is a high likelihood that a particular truck may topple and fall while on the road. In aspects, temperature data, precipitation data, road grade data, and an experience value associated with a driver of the truck (e.g., 5 years of experience, 10 years of experience, and so forth) may be analyzed to generate a risk score that is specific to the driver. Based on the risk score, an alert may be generated that informs the driver that the it would be advisable to stop driving or take an alternative route. In aspects, a map that differentiates between day and night and provides information of an area surrounding a driver's route based on the time of day (e.g., whether it is day or night) also aids in assessing the risk of the driver.

In aspects, customer data 118 may also be communicated directly by the customer server 110 to the main server 108, e.g., wirelessly, via the communication network 109. For example, customer data 118 corresponds to data provided by various types of companies such as electric utility companies, satellite companies, whole sale distributors, and so forth. The customer data 118 may be representative of geographic information and temporal information. In aspects, the customer data 118 may be representative of various types of information such as sales at a store location, number of traffic accidents at city intersections, water pressures at sewage processing plants, and so forth. The main server 108 may receive this data and convert this data into distinct layers (i.e. map layers) and utilize these distinct layers in association with layers that may be generated from the data received from the first data server 102, the second data server 104, and the third data server 106.

For example, one or more aspects of the data from each of the first data server 102, the second data server 104, and the third data server 106 may be represented by a distinct map layer (e.g., a first map layer, a second map layer, and a third map layer). Thereafter, one or more additional map layers may be generated that are specific to the customer data 118 provided by the customer server 110. All of these distinct map layers may be accessible by and specific to the preferences of the customer and be accessible via the customer server 110. In aspects, the customer data 118 may be data that captures or is representative of geographic information and temporal information.

In aspects, the system of the present disclosure enables the employees, engineers, designers, etc., of a company that utilizes the customer server 110 to select and set various thresholds specific to the data they provided (i.e. customer data 118). Further, in aspects, employees, designers, engineers, and so forth, of a company may also provide their own rules for combining the data associated with the map layers in various ways such that the results of these combinations may be useful to the clients of these companies in various ways. It is noted that these rules may be proprietary to each of the companies. Additionally, the system enables the customer to set various thresholds for the data collected from the first data server 102, the second data server 104, and the third data server 106, in conjunction with one or more thresholds set for the customer data 118.

In short, the system described herein enables a company (i.e. customer) to utilize the customer server 110 and simultaneously analyze data from the first data server 102, the second data server 104, the third data server 106, and the customer data 118 from the customer server 110, and generate various resultant datasets using the various thresholds. In aspects, the system described herein enables the customer server 110 to export all resultant datasets generated by the main server 108, store these resultant datasets, and input these datasets into one or more models operating on the customer server 110. For example, the resultant datasets may be input into one or more machine learning models, customer proprietary modeling programs, and so forth.

In aspects, the data received from the first data server 102, the second data server 104, the third data server 106, and customer server 110 (i.e. the customer data 118) may include a geographic and a temporal component and may be acquired from across the entire world. The main server 108 may generate summaries from this data, which may be accessible to the customer server 110, e.g., at fixed intervals, substantially in real time, and so forth. For example, layers associated with temperatures across the whole world (or specific to the territorial boundaries of a particular nation), traffic within a particular territorial boundary, data regarding fire zones data may be generated by the main server 108. Additionally, as stated above, another layer that is specific to and based entirely on data provided by the customer server 110 (e.g., customer data 118) may be combined or analyzed in conjunction with the temperature layer, traffic layer, and fire zones data layer.

In aspects, designers and engineers that work for a company that uses the customer server 110 may operate in conjunction with the main server 108 and request the system of the present disclosure generate resultant datasets (e.g., example resultant dataset 120) based on the layer representing the customer data 118, the temperature layer, traffic layer, and fire zones data layer. Updates based on the example resultant dataset 120 may be generated and communicated to the customer server 110 at various time periods, e.g., one an hour, once every five hours, once a day, and so forth.

In aspects, the main server 108 may operate the system such that the customer data 118 may be, e.g., multiplied by a particular value (e.g., 15), divided by a particular average temperature threshold, and then compared to a particular value (e.g., 26). In this way, the main server 108 may generate a layer (a layer representative of the example resultant dataset 120) that is based on and specific to the customer provided data (e.g., the customer data 118), and communicate this layer or aspects of data included in this layer to the customer server 110. In aspects, the customer server 110 may then communicate various updates to the devices of various clients, e.g., the first subscriber device 112, the second subscriber device 114, and the third subscriber device 116. It is noted that more complicated formulas may be implemented on the customer data 118 by the main server 108, e.g., a data layer may be generated based on the Autoregressive Integrated Moving Average (ARIMA) model for a certain time frame, e.g., the last 5 days.

In short, the system described herein provides companies (e.g., those that operate the customer server 110) with access to information extensively gathered from the first data server 102, the second data server 104, and the third data server 106, which these companies would not be able to access. Additionally, the system then enables analysis and interpretation of the data from each of these servers with the data obtained from the customer server 110. Finally, the system also enables generation of layers that are specific to data from the first data server 102, the second data server 104, the third data server 106, and data (e.g., customer data 118) received from the customer server 110.

In one example, the customer server 110 may be operated by an electric utility company that may utilize the system of the present disclosure to achieve outage prediction. To this end, the customer server 110 may provide customer data 118 in the form of distributed electric grid information to the main server 108. The main server 108 may generate a layer specific to the distributed electric grid information, and analyze the data defining with the distributed electric grid information in association with data received from each of the first data server 102, the second data server 104, and the third data server 106, e.g., weather and temperature data, traffic data, fire zones data, etc. It is noted that each of these data types may be generated into a specific map layer.

The electric utility company may be able to set various thresholds and parameters based on accessing the data from the three data servers illustrated in FIG. 1 and from the distributed electric grid information stored in the customer server 110 to better monitor and determine specific conditions. For example, using the four map layers, the electric utility company may be able to better determine conditions under which one or more power lines that are part of the distributed electric grid may melt or freeze. For example, if the temperatures fall below a particular threshold, an alert may be generated and communicated to the customer server 110 or an alert may appear, automatically and without user intervention, on a display that is communicatively coupled to the customer server 110. The alert may state that one or more power lines are in danger of freezing up. In aspects, these alerts may be communicated in the form of notifications (e.g., text messages, audio messages, and so forth) to a central component (e.g., a server) belonging to the company.

In such an instance, the utility company may increase an amount of current, which may be sent to the power lines in order to reduce the likelihood of the power lines freezing. The electric utility company would not have been able to do this without accessing data from various other sources, which is only feasible via use of the main server 108 and the system described herein. In aspects, the system described herein may also enable the transmission of additional information directly to the electric utility company, e.g., based on historical outage data provided by the utility company, the system may be able to predict with a high level of accuracy, the likelihood of outages occurring in the future, namely using the data from the first data server 102, the second data server 104, and the third data server 106. The utility company may also determine a number of people that may possibly be affected by such an outage. These are non-limiting examples.

It is noted that the visual representation and communication of the map layers generated by the main server 108 may be in the form of digital overlays that may be positioned on top of a digital map (e.g., a base map). Alternatively, the system may also operate as part of an API, and may also involve transmitting emails, text messages, and so forth, from the main server 108 to the customer server 110. In aspects, the system described herein may be implemented as a web service that is accessible by the customer server 110. In particular, the electric utility company may upload data related to their distributed electric grid into a website that is operated by the system described herein. Thereafter, the website may also provide access to data the first data server 102, the second data server 104, and the third data server 106, which the electric utility company may use to set up various filters, rules, and so forth. The filters may be, e.g., provide information regarding power lines located in areas where the temperatures in the past 2 weeks has fallen below −20 degrees Fahrenheit. Simultaneous access to the information regarding the power lines and the information regarding the temperatures within a particular geographic area and within a particular time frame enables for the accurate and efficient determination of instances in which a power line in an area may freeze. Such a determination would not be possible for the electric utility company without the system described herein.

In aspects, various parts of the above information may be output on a display that is communicatively coupled with the customer server 110. For example, the power lines may be displayed using a particular icon, while temperature values may be displayed using other icons that are superimposed or overlaid on top of the power lines icons. Both the power lines icons and the icons representing the temperature values may be overlaid on a digital base map provided by a third party provider. The electric utility company may select one or more of these icons and determine other relevant information. Alternatively, based on the preferences provided by the electric utility company to the main server 108, emails or text messages may be transmitted to the customer server 110 indicating that one or more power lines has likely frozen or otherwise damaged based on satisfaction of various conditions, e.g., temperature conditions, weather variations, and so forth.

Broadly speaking, the system described herein may operate by simply implementing various rules provided by the customer server 110 and by combining the data provided by the customer server 110. In other aspects, the system may receive the data from the customer server 110 and generate a set of formulas based on various factors provided by the customer server 110. The results of the implementation of these rules may be readily available via the customer server 110, e.g., substantially in real time or at fixed time intervals, or may be communicated by the main server 108 to the customer server 110.

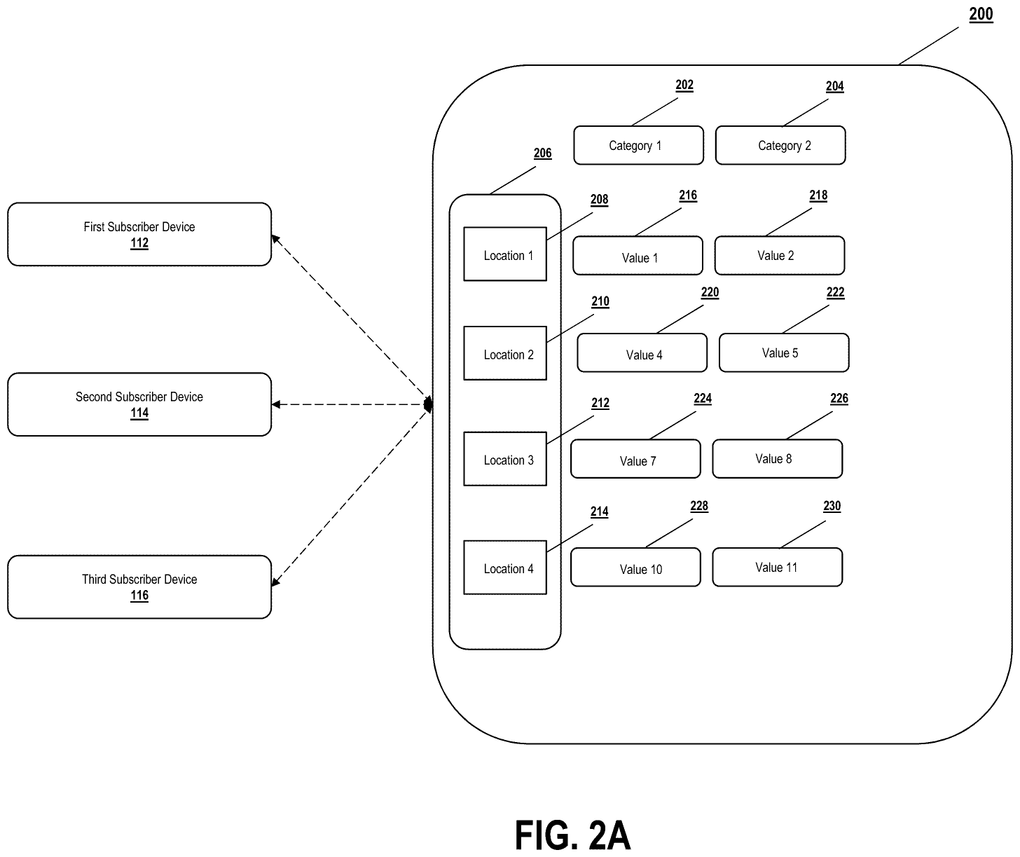

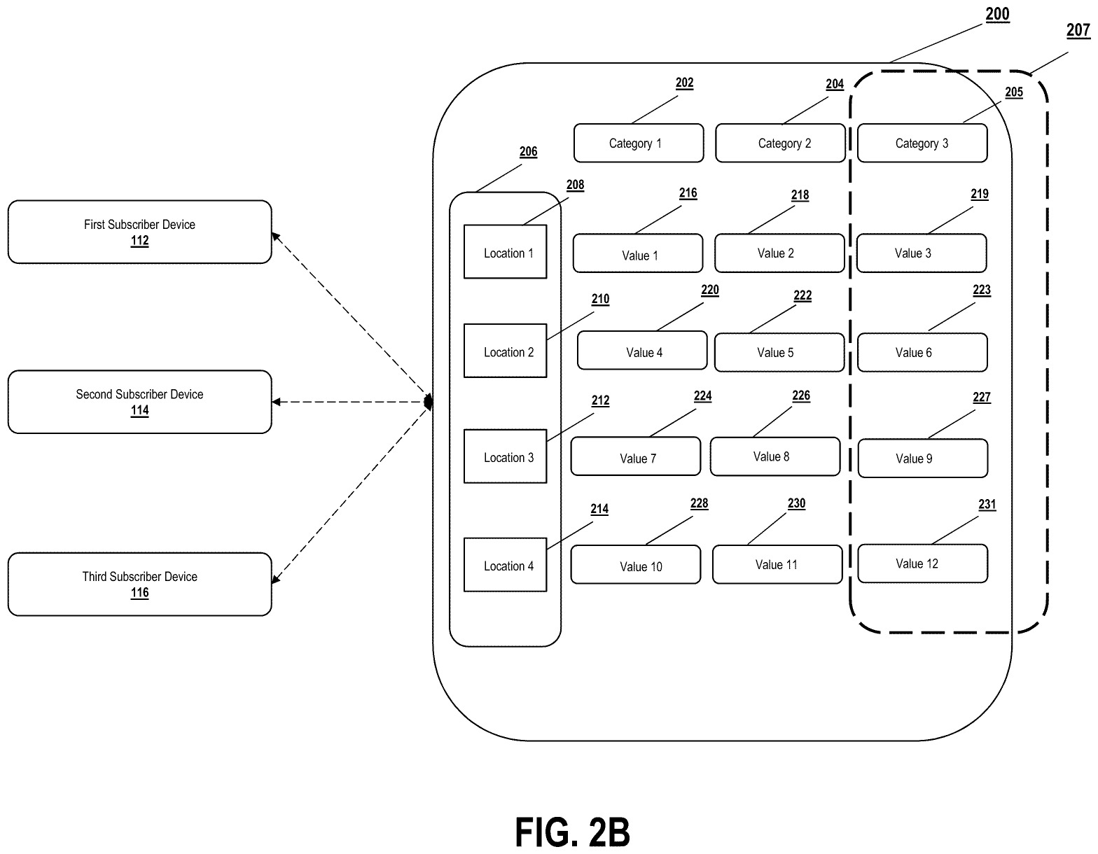

FIG. 2A depicts an example graphical representation 200 of a user interface associated with the software application of the system of the present disclosure, according to one or more aspects described and illustrated herein. In particular, the example graphical representation 200 illustrated in 2A may be output on a display that is communicatively coupled to one or more computing devices installed as part of each of the first subscriber device 112, the second subscriber device 114, and the third subscriber device 116. In aspects, the example graphical representation 200 may also be accessible via and output on a display that is coupled to the client server 110. The client server 110 may then share the example graphical representation 200, via the software application operating on the client server 110 and each of the first, second, and third subscriber devices 112, 114, and 116, substantially in real time. In aspects, the graphical representation 200 may include a listing 206 associated with store locations of a national or international grocery chain. For example, the listing 206 may include example interactive icons 208, 210, 212, and 214 icons representative of four store locations. These locations may be represented by example interactive icons 208, 210, 212, and 214.

In aspects, various categories of data may be included in association with each of these grocery stores, e.g., category 1 and category 2, which may be represented by example interactive icons 202 and 204. In aspects, category 1 may correspond to temperature data specific to an area within a particular vicinity of each of the locations, e.g., 5 mile radius, 10 mile radius, 20 mile radius, and so forth, and at a particular time, e.g., during a specific time of day, during a week, and so forth. Such temperature data may be represented by values 1, 4, 7, and 10, which may be displayed within the example interactive icons 216, 220, 224, and 228. These values may be updated, substantially in real time, based on changes in temperatures, which may be tracked, monitored, and analyzed by the main server 108, and subsequently communicated to the client server 110.

In aspects, category 2 may correspond to a numeric value range or an alphanumeric value range representative of a likelihood of a storm, the likelihood of winds meeting or exceeding a particular range, and so forth. These values, e.g., values 2, 5, 8, and 11, may be displayed within the example interactive icons 218, 222, 226, and 230, and may be associated with a particular vicinity or distance from the store locations 1, 2, 3, and 4, e.g., 5 mile radius, 10 mile radius, 20 mile radius, and so forth. Additionally, in aspects, these values may be tracked, monitored, and analyzed by the main server 108, and subsequently communicated to the client server 110, which may then communicate the updated values to the computing devices of each of the first subscriber device 112, the second subscriber device 114, and the third subscriber device 116. The updated values may be outputs on respective displays to which these devices are communicatively coupled.

In aspects, the values associated with interactive icons 216, 220, 224, and 228 correspond to a particular data layer (e.g., a first resultant dynamic data layer) and the values associated with interactive icons 218, 222, 226, and 230 correspond to another data layer (e.g., a second resultant dynamic data layer). It is noted that each of these data layers may be updated, analyzed, and combined in order to modify the values of these generated resultant dynamic data layers. As stated above, the resultant dynamic data layers may be generated by the main server 108 and communicated to the client server 110, which may route these layers to one or more of the subscriber devices. The generation of the first resultant dynamic data layer (e.g., associated with temperature data) may include analyzing temperature data received from, e.g., the first data source server 102, and performing various operations.

These operations may include changing the format of the temperature data, performing normalization operations on the temperature data, adding weighting parameters to one or more of the temperature data according to customer criteria, and corresponding the temperature data to latitude and longitude values, one or more of which are associated with various store locations. It is noted that, in addition to the temperature data, normalization operations, the addition of weighting parameters according to customer criteria and preferences, and so forth, may be performed with respect to a plurality of other types of data such as traffic data, general weather data, traffic data, wind data, fire zones data, and so forth. These are non-limiting examples of the various types of data. In this way, the temperature values specific to a store location or within a particular vicinity of the store location may be determined and included as part of the first resultant dynamic data layer (e.g., resultant dynamic dataset). In other aspects, the second resultant dynamic data layer corresponding to a likelihood of a storm, the likelihood of winds meeting or exceeding a particular range, and so forth, may also be similarly determined in a manner that is similar to the manner in which the first resultant dynamic data layer is determined. In aspects, the generation of the second dynamic data layer (e.g., associated with storm data, wind speed data, and so forth), may include the main server 108 receiving wind speed data, data associated with a likelihood of a storm, etc., and performing various data format transformation operations, normalization operations, in addition to adding weighting parameters to the storm data and wind speed data. It is noted that data descriptive of other environmental factors such as, e.g., humidity, air quality, pressure, and so forth, are also contemplated.

It is noted that the first and second resultant dynamic data layers may be generated and updated at predetermined intervals or cadences that match the cadence or intervals associated with the data collected by the first data source server 102, the second data source server 104, and/or the third data source server 106. In aspects, the resultant dynamic data layers may be generated based on environment data such as weather, traffic, air quality, etc. In other aspects, the resultant dynamic data layers may also be generated based on data related to road accidents data, traffic data, and so forth. In other aspects, data layers may be generated based on financial information such as sales volume at a particular store, medical information related to a hospital such as, e.g., number of hospital visits, emergency room visit rates and types, additional monitoring, alerting, and analysis. In other aspects, data layers may be generated based on data associated with road segments, governmental boundaries, topographies, rail networks, power grids, population densities, power grids, and so forth. It is noted that these are non-limiting examples.

FIG. 2B depicts an example graphical representation 200 in which an additional resultant dynamic data layer is included as part of the example graphical representation 200, according to one or more aspects described and illustrated herein. In aspects, the additional resultant dynamic data layer 207 may include a category 3 and a plurality of values, namely values 3, 6, 9 and 12 included as part of the example interactive icons 205, 219, 223, 227, and 231. The additional resultant dynamic data layer 207 may be included automatically and without user intervention as part of the example graphical representation 200 or may be manually selected for inclusion by one or more input provided by operators associated with the first subscriber device 112, the second subscriber device 114, and the third subscriber device 116. The category 3 may correspond to traffic data or data representative of vehicle routes. For example, values, 3, 6, 9, and 12, respectively, may be representative of routes specific to different vehicles that may be transporting goods (e.g., produce) from particular source locations to store locations 1, 2, 3, and 4, respectively. In aspects, selecting each of the example interactive icons 219, 223, 227, and 231 may result in a display of an additional graphical representation, e.g., an interactive digital map, that may be output or presented adjacent to or overlaying the data presented in the example graphical representation 200. In aspects, an entirely different digital page may be presented on the displays associated with the first subscriber device 112, the second subscriber device 114, and the third subscriber device 116, each of which may include respective interactive maps.

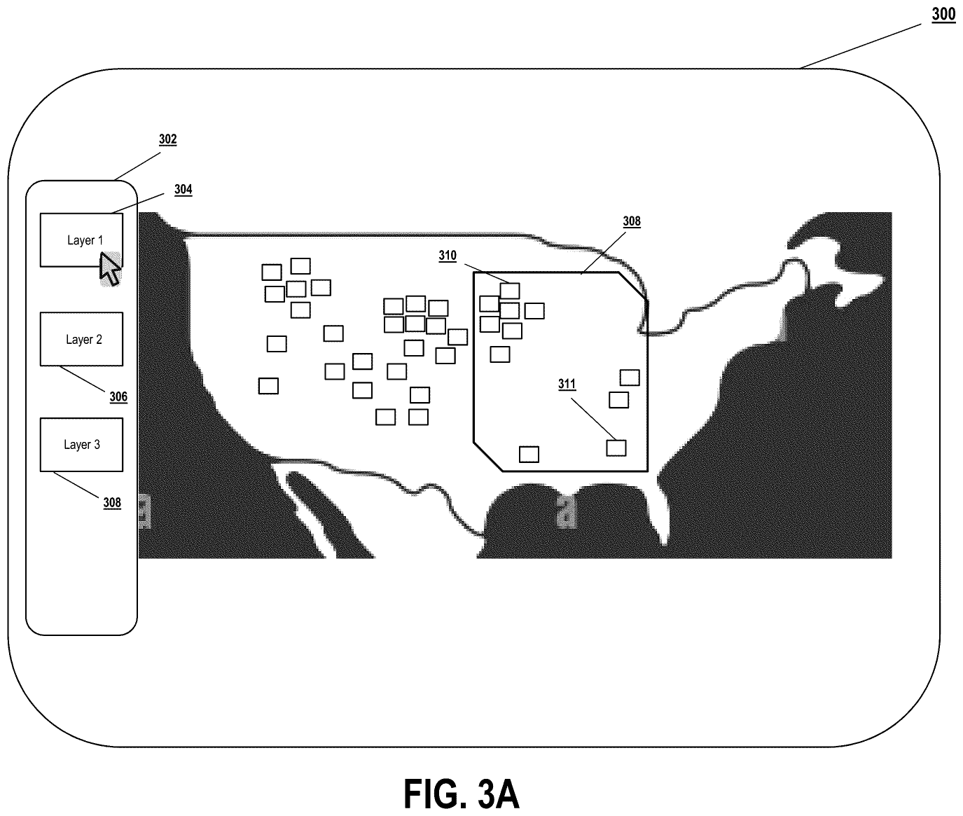

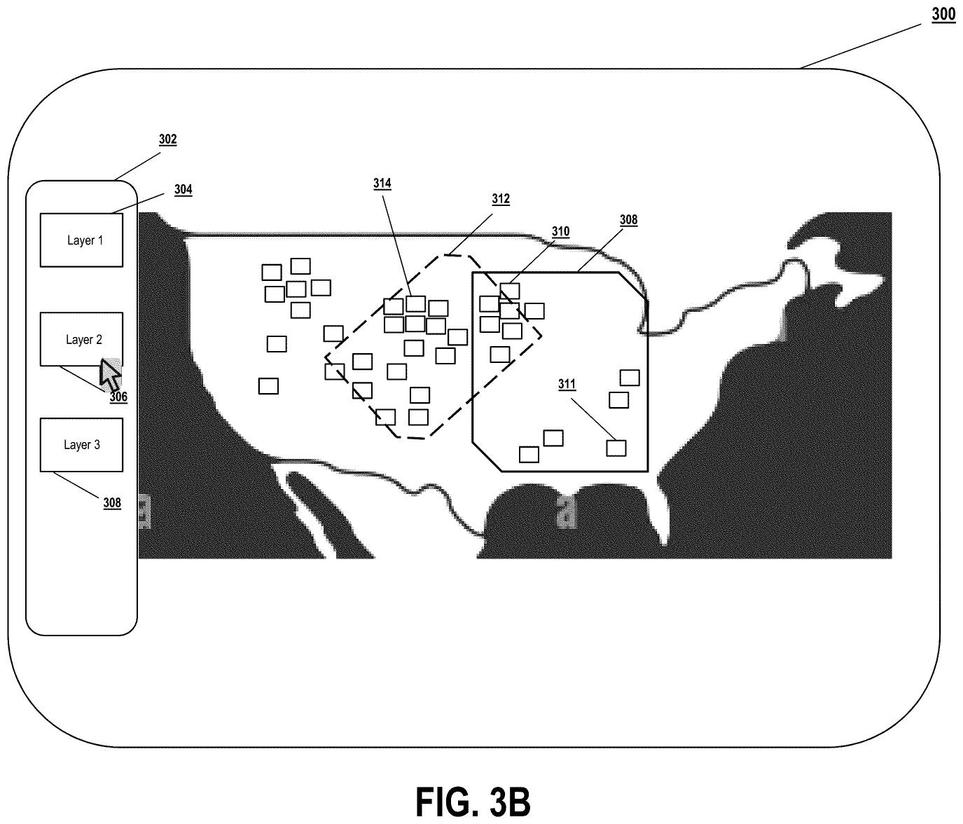

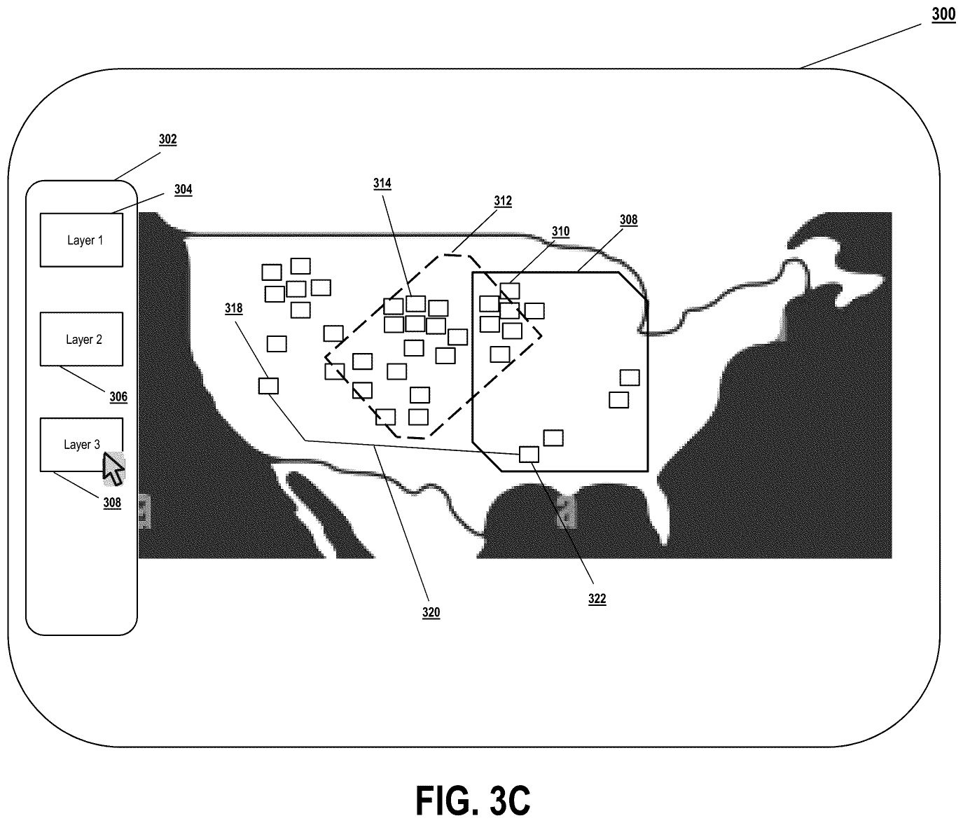

In aspects, an example of the interactive digital map is described below and provided in FIGS. 3A-3C.

FIG. 3A depicts an example interactive digital map 300 that includes a plurality of store locations across a geographical area and an example resultant dynamic dataset upon which a temperature graphic 308 (e.g., an example result dynamic data layer) is output on a portion of the interactive digital map 300, according to one or more aspects described and illustrated herein. Further, as illustrated in FIG. 3A, the example interactive digital map 300 may include a panel 302 that includes a plurality of example interactive icons 304, 306, and 308, which are associated with a plurality of data layers corresponding to a plurality of resultant dynamic datasets, e.g., the first resultant dynamic data set, the second resultant dynamic dataset, and a third resultant dynamic dataset. Layers 1, 2, and 3, which may be associated with example interactive icons 304, 306, and 308, may represent temperature data, wind and/or fire zones data, and traffic data and/or travel route data, respectively. It is noted that while an example interactive digital map 300 is illustrated in FIG. 3A, the dynamic dataset generation system of the present disclosure may operate to represent resultant dynamic dataset in various ways and formats, e.g., digital reports, digital streams that are compliant with one or more software applications that are proprietary to the client server 110 and the first, second, and third, subscriber devices 112, 114, and 116, and so forth.

Returning to the example interactive digital map 300, an operator may select the example interactive icon 304 corresponding to the layer 1, as a result of which a temperature graphic 308 corresponding to the layer 1 may be displayed on a portion of the interactive digital map 300. For example, the temperature graphic 308 may be shaded to correspond to a particular color, texture, and so forth. The color and/or texture may vary from across various parts of the temperature graphic 308. For example, a top left portion of the temperature graphic 308 that is close to a store location icon 310 may have a light color and represent a temperature range of, e.g., from 45 degrees Fahrenheit to 60 degrees Fahrenheit, while the bottom right portion of the temperature graphic 308 that is close to a store location icon 311 may have a darker color and represent a temperature range of, e.g., from 90 degrees Fahrenheit to 102 degrees Fahrenheit. In aspects, the temperature graphic 308 may be interactive such that an operator may select one or more of the icons representing the store locations, e.g., store location 310 and/or store location icon 311, and be presented with substantially real time updates of the temperatures specific to the store location icons 310 and 311, such as temperatures within a particular vicinity or distance of the store locations 310 and 311, e.g., 10 miles, 15 miles, 20 miles, and so forth. In aspects, the temperature or temperature range information may be provided in the form of a pop-up graphic that may be displayed adjacent to the store location icons 310 and 311. The pop-up graphics may be displayed for a predetermined period of time adjacent to the store location icons 310 and 311.

In aspects, one or more alerts may be generated and transmitted to one or more of the first subscriber device 112, the second subscriber device 114, and the third subscriber device 116. For example, if the temperature value or temperature range in a particular area of interest for a client, which may be indicated on the example interactive digital map 300, exceeds a particular level, an alert may be automatically generated and transmitted to one or more of the first subscriber device 112, the second subscriber device 114, and/or the third subscriber device 116. For example, an operator associated with a client may set a temperature preference specific to a store location, e.g., the store represented by the store location icon 311. As such, if temperatures within a particular vicinity of the store location exceeds a level, e.g., 90 degrees Fahrenheit, an alert may be generated and output on the example interactive digital map 300. Alternatively or additionally, in other aspects, the alert may be generated and transmitted to one or more of the first subscriber device 112, the second subscriber device 114, and the third subscriber device 116.

FIG. 3B depicts an example interactive digital map 300 that includes a plurality of store locations across a geographical area and an additional example resultant dynamic dataset upon which an example graphic 312 is generated (e.g., an example result dynamic data layer) may be output on a portion of the interactive digital map 300, according to one or more aspects described and illustrated herein. In aspects, the operator may select the example interactive icon 306 corresponding to the layer 2, as a result of which an example graphic 312 corresponding to the layer 2 may be displayed on a portion of the interactive digital map 300. In aspects, an example graphic 312 may be generated in a shape that is substantially similar to a square and is shown with dotted lines. In aspects, similar to the temperature graphic 308, the example graphic 312 may indicate or include different colors at different locations. For example, a center left portion of the example graphic 312 adjacent to a store location icon 314 may be shown to include a dark color while another portion may be shown with a lighter color. A dark color may be representative of a likelihood of a fire zone with a distance range relative to the store location icon 314, e.g., 10 miles, 15 miles, 20 miles, and so forth. Similar to the temperature graphic 308 of FIG. 3A, the example graphic 312 is interactive and may function such that if an operator selects the store location icon 314 or a portion of the example graphic 312, a pop-up graphic may be displayed adjacent to the store location icon 314 for a predetermined time frame. The pop-up graphic may include detailed information regarding the likelihood of a fire or fire hazard information within a vicinity of the store location icon 314.

It is noted that while the example graphic 312 and the temperature graphic 308 is shown in the form of shapes that are substantially similar to rectangles, other shapes, graphics, and/or formats may also be utilized. For example, the small rectangles that are included across the interactive digital map 300, which are representative of store location icons, may also be represented in the form of dots or points, larger circles, and so forth. In aspects, the dots or points may also be representative of, e.g., houses, distribution centers, automobile repair locations, current locations of automobiles and drones, etc. In aspects, a current or future condition (e.g., environmental conditions, traffic conditions, and so forth) associated with each of the points, lines, and so forth, may be monitored in real time.

In aspects, monitoring of a condition may involve determining whether a point satisfies a condition, e.g., temperature value, likelihood value associated with a fire, and so forth. In other aspects, monitoring of a condition may involve obtaining data associated with various portions or partitions of a line that may be representative of, e.g., a truck route, a commute, a drone flight, a rail line, a power line, and so forth. In aspects, approximately real time information may be provided to the client server 110 and/or one or more of the subscriber devices associated with temperature and other weather related changes along a route, e.g. during a particular time window. For example, if a sudden storm or heavy rain is forecasted for the next 2-3 hours, this information may be output in the form of an alert that may appear on the example interactive digital map 300. Alternatively, the alert may be transmitted, via the communication network 109, to one or more of the subscriber devices, a smartphone of an operator, a laptop of an operator, and so forth. In aspects, monitoring of information may also involve determining average temperatures for a particular area, minimum and maximum temperatures for a particular area, various probability distributions associated with temperatures, and so forth. In other aspects, any alerts that are generated may be customized and tailored in accordance with the preferences of various clients. Further, in aspects, the alerts may be configured to occur at particular time intervals or may not repeat until an alert value is changed or modified by a particular amount. In aspects, boolean values in combination with a plurality of conditions may be utilized to configure the alerts.

FIG. 3C depicts a vehicle travel route graphic 320 connecting two store locations, according to one or more aspects described and illustrated herein. In aspects, the operator may select an example interactive icon 309 corresponding to the layer 3, as a result of which a vehicle travel route graphic 320 corresponding to the layer 3 may be displayed on a portion of the interactive digital map 300. As illustrated, the vehicle travel route graphic 320 may connect a store represented by a store location icon 318 with another store represented by another store location icon 322. It is noted the vehicle travel route graphic 320 corresponds to a line or path that is partitioned in accordance with a plurality of line segments or path segments. The vehicle travel route graphic 320 may correspond to a route that is specific to a vehicle, a drone, a truck, a rail, and so forth. In aspects, each part of the vehicle travel route graphic 320 may be user selectable.

In operation, upon selection of a particular line segment or path segment of the vehicle travel route graphic 320, various types of data may be output. For example, a part of the line segment may be shown in a particular color and another part of the line segment may be shown in a different color. A first color may indicate that a particular part of the vehicle travel route graphic 320 has a lot of traffic or that a number of accidents may have occurred along this particular path segment. In other aspects, another line segment may be highlighted with a second color that is indicative of a high likelihood of a fire or high temperatures that exceed particular conditions (e.g., threshold levels). In yet other aspects, one or more of the line segments or path segments may be highlighted or indicated with a color that represents traffic data, e.g., likelihood of an accident that is above a particular value, heavy traffic, and so forth.

In aspects, as shown in FIGS. 3A-3C, the temperature graphic 308 and the example graphic 312 are shown to have a substantially rectangular shape. However, other shapes are also contemplated. In aspects, the areas represented by the temperature graphic 308 and the example graphic 312 may correspond to governmental boundaries, e.g., countries, counties, and so forth. Further, in aspects, these areas may correspond to an area with a specific drive time of a particular point in the interactive digital map 300. In other aspects, as stated above, these areas may correspond to dynamic polygons, potential active fire zones, and so forth. In aspects, these zones may be identified using remote sensing data that may be obtained by one or more devices that may be communicatively coupled to one of more of the first data source server 102, the second data source server 104, and the third data source server 106.

In aspects, in addition to the example interactive digital map 300, an augmented reality or virtual reality based device that operates the software of the resultant dynamic data generation system may also be utilized to display various aspects of a generated resultant dataset. For example, for each of the FIGS. 3A-3C, the example interactive digital map 300 may be output on a head-mounted display (HMD) that may be worn by an operator of a vehicle such as, e.g., a truck, a car, and so forth. In aspects, one or more of the data layers (e.g., Layer 1, Layer 2, and Layer 3) may be displayed on the display of the HMD. Graphical representations that are shown on the HMD include, e.g., data relating to dangerous conditions for driving a vehicle, data regarding temperature variations, incidents of fire hazards within a particular proximity of the location of the vehicle in which the operator is located, and so forth. In other aspects, the resultant dynamic data generation system may also generate resultant datasets that may be utilized as part of a virtual conference, game, simulation, or simulation software that is part of a meta-verse.

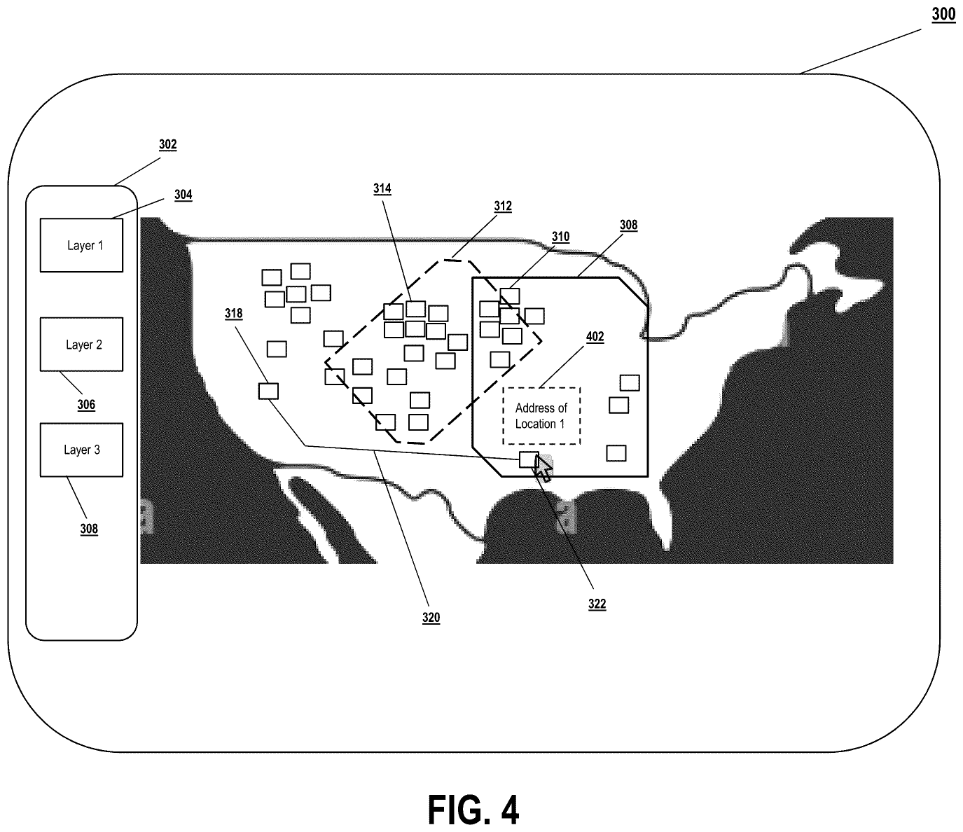

FIG. 4 depicts an example a pop-up window that is displayed upon a selection of a store location icon 322, according to one or more aspects described and illustrated herein. As illustrated in FIG. 4, upon selection of the store location icon 322, an address graphic 402 may be output adjacent to the store location icon 322. It is noted that, as non-limiting examples, other types of data may also be presented, such as temperature data, fire zones data, traffic data, and so forth.

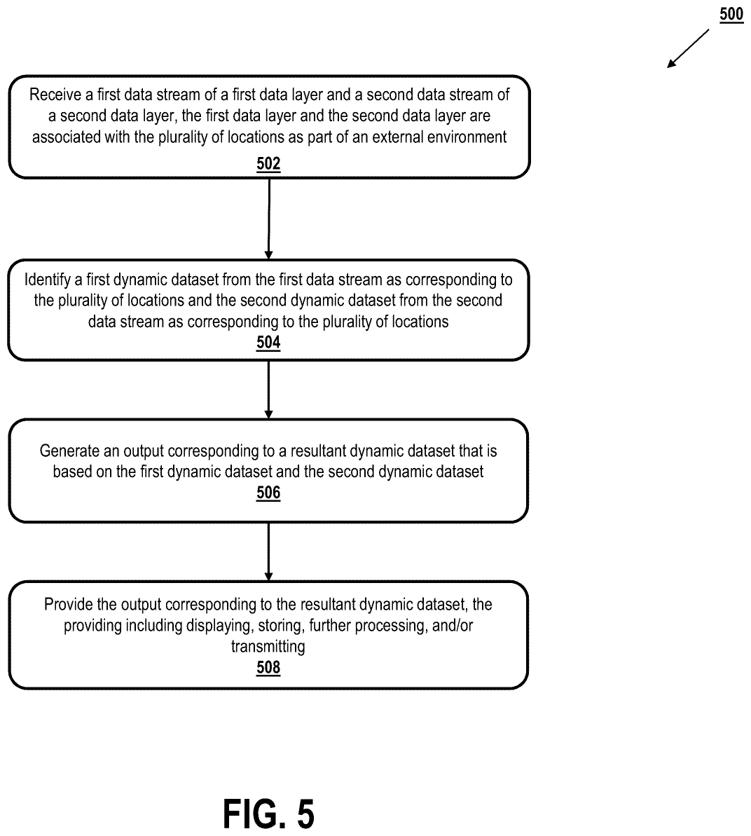

FIG. 5 depicts a flow chart 500 for generating and providing a resultant dynamic dataset, according to one or more aspects described and illustrated herein. At block 502, a first data stream of a first data layer and a second data stream of a second data layer may be received. Each of the first data layer and the second data layer may be associated with a plurality of locations as part of an external environment. As described above, various data streams may be received from various sources, e.g., data sources that collect weather data, traffic data, data related to fire zones, shipping routes, flight routes, and so forth. These are non-limiting examples. In aspects, the main server 108 may operate to associate one or more of the data streams with one or more data layers. In aspects, these data layers may be transmitted in various formats and in accordance with various client preferences to one or more client devices, e.g., the client server 110, and/or the first subscriber device 112, the second subscriber device 114, and the third subscriber device 116.

At block 504, a first dynamic dataset from the first data stream corresponding to the plurality of locations and a second dynamic dataset from the second data stream corresponding to the plurality of locations may be generated. In aspects, the generation of the first dynamic dataset and the second dynamic dataset may involve transforming the data from a first format to a second format such as changing a format of an image from a .gif extension to a .jpeg extension. Additionally, in aspects, various processes may be implemented on the data, e.g., one or more normalization operations, and so forth. Further, one or more steps may involve one or more of a plurality of mathematical operations that may be performed on the first dynamic dataset and the second dynamic dataset. In aspects, the first dynamic dataset is associated with at least one of the plurality of locations at a specific time and the second dynamic dataset may be associated with at least an additional one of the plurality of locations at a specific time. For example, temperature data and data pertaining to fire zones may be associated with a particular geographic location at a specific time.

At block 506, an output corresponding to a resultant dynamic dataset that is based on the first dynamic dataset and the second dynamic dataset may be generated. In aspects, the resultant dynamic dataset may be based on combining the first dynamic dataset corresponding to temperature values and the second dynamic dataset corresponding to wind values, fire zone values, and so forth. In aspects, a third data stream of a third data layer associated with the external environment may be received and a third dynamic dataset from the third data stream corresponding to the plurality of locations may be generated. In aspects, the third data stream may be associated with traffic data. It is noted that a resultant dataset that is generated at block 506 may be modified to include at least a value from the third dynamic dataset. In aspects, a data value from the first dynamic dataset that is specific to a location from the plurality of locations is determined. In aspects, the data value may satisfy a condition. In aspects, an alert in response to the data value satisfying a condition may be generated. The alert may be output and transmitted in real time and may be in the form of a graphical representation, a text, and so forth.

At block 508, the output corresponding to the resultant dynamic dataset is provided. In aspects, the providing of the output corresponding to the resultant dynamic dataset may include displaying, storing, further processing, and/or transmitting the resultant dynamic dataset. In aspects, the resultant dynamic dataset may be included as part of a graphical representation such as e.g., an interactive digital map. In other aspects, the resultant dynamic dataset may be included as part of the packaged data stream that may be communicated by the main server 108 to the client server 110 via the communication network 109.

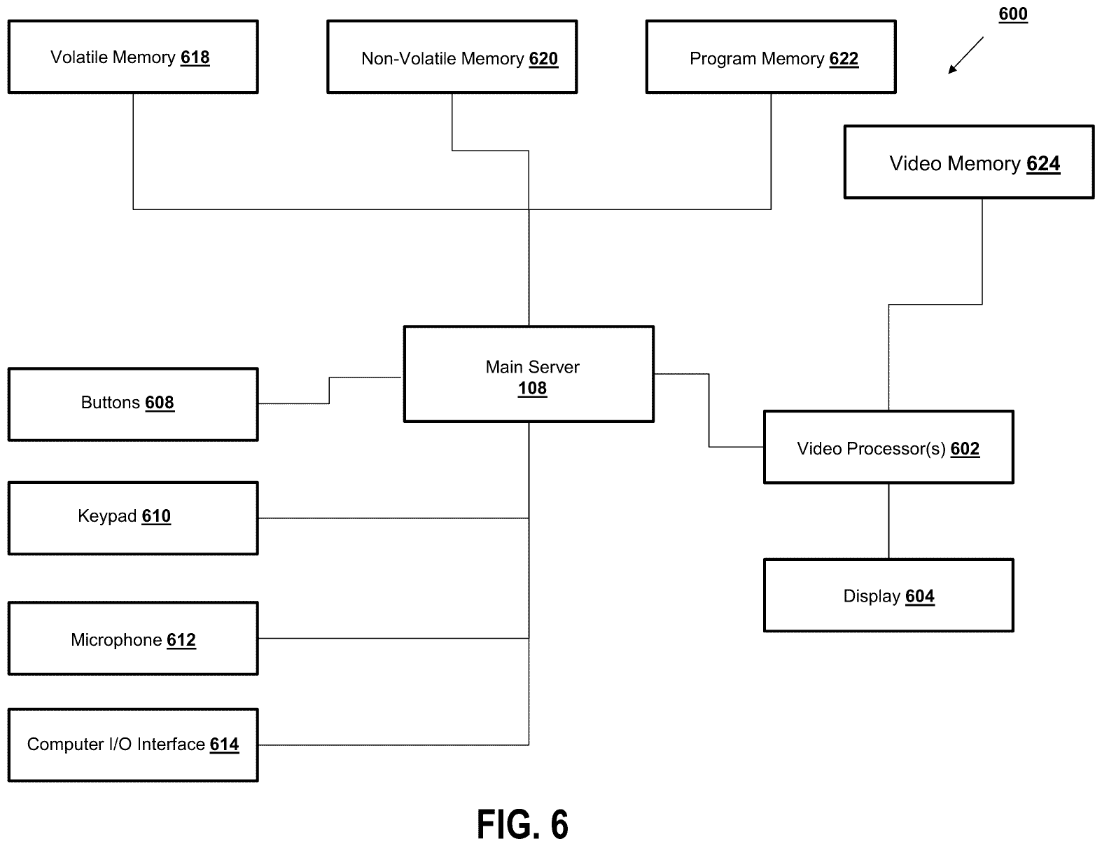

FIG. 6 depicts the main server 108 that may implement the resultant dynamic dataset generation system as described in the present disclosure, according to some aspects described and illustrated herein. The computing system 600 may include the main server 108 that is communicatively coupled (wired or wirelessly coupled) to a display 604, a keypad 610 (e.g., a keyboard) one or more sensors implanted in the brain of a patient, and one or more brain machine interfaces that are external to the main server 108. The main server 108 may also include video processors 602, buttons 608, a microphone 612, a computer input/output interface 614, memory in the form of volatile memory 618, non-volatile memory 620, and program memory 622.

The video processors 602 can provide/receive commands, status information, streaming video, still video images, and graphical overlays to/from the main server 108 and may be comprised of Field Programmable Gate Arrays (“FPGAs”), Digital Signal Processors (“DSPs”), or other processing elements which provide functions such as image capture, image enhancement, graphical overlay merging, distortion correction, frame averaging, scaling, digital zooming, overlaying, merging, flipping, motion detection, and video format conversion and compression.

The main server 108 can be used to manage the user interface by receiving input via buttons 608, keypad 610, and/or microphone 612, in addition to providing a host of other functions, including image, video, and audio storage and recall functions, system control, and measurement processing. The buttons 608 and/or keypad 610 also can be used for menu selection, providing user commands, and so forth.

The video processors 602 can also communicate with video memory 624, which is used by the video processors 602 for frame buffering and temporary holding of data during processing. The main server 108 can also communicate with program memory 622 for storage of programs executed by the main server 108. In addition, the main server 108 can be in communication with the volatile memory 618 (e.g., Random Access Memory or “RAM”), and the non-volatile memory 620 (e.g., flash memory device, a hard drive, a DVD, or an Erasable programmable read-only memory (“EPROM”) memory device). The non-volatile memory 620 is the primary storage for streaming video and still images.

The main server 108 can also be in communication with a computer input/output interface 614, which provides various interfaces to peripheral devices and networks, such as universal serial bus (USB), Firewire, Ethernet, audio I/O, and wireless transceivers. This computer input/output interface 614 can be used to save, recall, transmit, and/or receive still images, streaming video, or audio. For example, a USB “thumb drive” or CompactFlash memory card can be plugged into computer input/output interface 614. In addition, the computing system 600 can be configured to send frames of image data or streaming video data to an external computer or server. The computing system 600 can incorporate a TCP/IP communication protocol suite and can be incorporated in a wide area network including a plurality of local and remote computers, each of the computers also incorporating a TCP/IP communication protocol suite.

Further non-limiting aspects or aspects are set forth in the following numbered clauses:
Clause 1: A method implemented by a computing device, the method including: receiving a first data stream of a first data layer associated with a plurality of locations included as part of an external environment, receiving a second data stream of a second data layer, generating a first dynamic dataset from the first data stream as corresponding to the plurality of locations and a second dynamic dataset from the second data stream as corresponding to the plurality of locations, generating an output corresponding to a resultant dynamic dataset that is based on the first dynamic dataset and the second dynamic dataset, the generating of the output including associating at least one value from the first dynamic dataset and at least one value from the second dynamic dataset with at least one of the plurality of locations, and providing the output corresponding to the resultant dynamic dataset, the providing including at least one of displaying, storing, further processing, and/or transmitting.
Clause 2: The method of clause 1, wherein the first dynamic dataset is associated with at least one of the plurality of locations at a specific time.
Clause 3: The method of clause 1 or 2, further including receiving a third data stream of a third data layer associated with the external environment, and generating a third dynamic dataset from the third data stream corresponding to the plurality of locations
Clause 4: The method of any of clauses 1 to 3, further comprising modifying the output corresponding to the resultant dynamic dataset, the modifying including associating at least one of the third dynamic dataset with at least one of the plurality of locations.
Clause 5: The method of any of clauses 1-4, further comprising: determining that a data value from the first dynamic dataset, which is specific to a location from the plurality of locations, satisfies a condition, and generating an alert responsive to the satisfaction of the condition.
Clause 6: The method of any of clauses 1-5, further comprising transmitting the alert to at least one additional device that is external to the computing device, and enabling outputting of the alert on an additional display that is coupled to the at least one additional device.
Clause 7: The method of any of clauses 1-6, further comprising determining that a data value from the second dynamic dataset, which is specific to the location from the plurality of locations, satisfies an additional condition, generating an additional alert responsive to the satisfaction of the additional condition, transmitting the additional alert to the at least one additional device that is external to the computing device, and enabling outputting of the additional alert to the additional display that is coupled to the at least one additional device.
Clause 8: The method of any of clauses 1-7, further comprising generating an additional output corresponding to an additional resultant dynamic dataset, the additional resultant dynamic dataset is based on the first dynamic dataset, the second dynamic dataset, the third dynamic dataset, and the plurality of locations. And outputting the additional resultant dynamic dataset on a display.
Clause 9: The method of any of clauses 1-8, wherein the outputting of the additional resultant dynamic dataset on the display including simultaneously displaying a plurality of interactive icons representative of the plurality of locations and graphical data representative of the first dynamic dataset, the second dynamic dataset, and the third dynamic dataset.
Clause 10: The method of any of clauses 1-9, further comprising: receiving, by the computing device, a selection of one of the plurality of interactive icons that is associated with a location of the plurality of locations, and displaying, responsive to the selection, an information graphic including data specific to the location of the plurality of locations.
Clause 11: The method of any of clauses 1-10, wherein the displaying includes simultaneously outputting the information graphic with the plurality of interactive icons representative of the plurality of locations and graphical data representative of the first dynamic dataset, the second dynamic dataset, and the third dynamic dataset.
Clause 12: A system comprises at least one data processor, a displayed coupled to the at least one data processor, and memory storing instructions which, when executed, cause the at least one data processor to perform operations comprising: receiving a first data stream of a first data layer associated with a plurality of locations included as part of an external environment, receiving a second data stream of a second data layer, generating a first dynamic dataset from the first data stream as corresponding to the plurality of locations and a second dynamic dataset from the second data stream as corresponding to the plurality of locations, generating an output corresponding to a resultant dynamic dataset that is based on the first dynamic dataset and the second dynamic dataset, the generating of the output including associating at least one value from the first dynamic dataset and at least one value from the second dynamic dataset with at least one of the plurality of locations, and providing the output corresponding to the resultant dynamic dataset, the providing including at least one of displaying, storing, further processing, and/or transmitting.
Clause 13: The system of clause 12, wherein the first dynamic dataset is associated with at least one of the plurality of locations at a specific time.
Clause 14: The system clause 12 or clause 13, wherein the operations further include receiving a third data stream of a third data layer associated with the external environment, and generating a third dynamic dataset from the third data stream corresponding to the plurality of locations.
Clause 15: The system of clause 14, wherein the operations further include modifying the output corresponding to the resultant dynamic dataset, the modifying including associating at least one value of the third dynamic dataset with at least one of the plurality of locations.
Clause 16: The system of any of clauses 12-15, wherein the operations further include determining that a data value from the first dynamic dataset, which is specific to a location from the plurality of locations, satisfies a condition; and generating an alert responsive to the satisfaction of the condition.
Clause 17: The system of any of clauses 12-16, wherein the operations further include transmitting the alert to at least one additional device that is external to the at least one data processor, and enabling outputting of the alert on an additional display that is coupled to the at least one additional device.
Clause 18: The system of any of clauses 12-17, wherein the operations further include determining that a data value from the first dynamic dataset, which is specific to a location from the plurality of locations, satisfies an additional condition, and generating an alert responsive to the satisfaction of the additional condition.
Clause 19: The system of any of clauses 12-18, wherein the operations further include: transmitting the alert to at least one additional device that is external to the at least one data processor and a display that is communicatively coupled to the at least one data processor, and enabling outputting of the alert on an additional display that is coupled to the at least one additional device.
Clause 20: The system of any of clauses 12-19, wherein the operations further include generating an additional output corresponding to an additional resultant dynamic dataset is based on the first dynamic dataset, the second dynamic dataset, the third dynamic dataset, and the plurality of locations, and outputting the additional output corresponding to the additional resultant dynamic dataset on a display that, the outputting including simultaneously displaying a plurality of interactive icons representative of the plurality of locations and graphical data representative of the first dynamic dataset, the second dynamic dataset, and the third dynamic dataset.

In the foregoing description, aspects and aspects of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A method implemented by a computing device, the method comprising:
receiving a first data stream of a first data layer associated with a plurality of locations included as part of an external environment;
receiving a second data stream of a second data layer;
generating a first dynamic dataset from the first data stream as corresponding to the plurality of locations and a second dynamic dataset from the second data stream as corresponding to the plurality of locations;
generating an output corresponding to a resultant dynamic dataset that is based on the first dynamic dataset and the second dynamic dataset, the generating of the output including associating at least one value from the first dynamic dataset and at least one value from the second dynamic dataset with at least one of the plurality of locations; and
providing the output corresponding to the resultant dynamic dataset, the providing including at least one of displaying, storing, further processing, and/or transmitting.

2. The method of claim 1, wherein the first dynamic dataset is associated with at least one of the plurality of locations at a specific time.

3. The method of claim 1, further comprising:
receiving a third data stream of a third data layer associated with the external environment; and
generating a third dynamic dataset from the third data stream corresponding to the plurality of locations.

4. The method of claim 3, further comprising modifying the output corresponding to the resultant dynamic dataset, the modifying including associating at least one value of the third dynamic dataset with at least one of the plurality of locations.

5. The method of claim 1, further comprising:
determining that a data value from the first dynamic dataset, which is specific to a location from the plurality of locations, satisfies a condition; and
generating an alert responsive to the satisfaction of the condition.

6. The method of claim 5, further comprising:
transmitting the alert to at least one additional device that is external to the computing device; and
enabling outputting of the alert on an additional display that is coupled to the at least one additional device.

7. The method of claim 6, further comprising:
determining that a data value from the second dynamic dataset, which is specific to the location from the plurality of locations, satisfies an additional condition;
generating an additional alert responsive to the satisfaction of the additional condition;
transmitting the additional alert to the at least one additional device that is external to the computing device; and
enabling outputting of the additional alert to the additional display that is coupled to the at least one additional device.

8. The method of claim 3, further comprising:
generating an additional output corresponding to an additional resultant dynamic dataset, the additional resultant dynamic dataset is based on the first dynamic dataset, the second dynamic dataset, the third dynamic dataset, and the plurality of locations; and
outputting the additional resultant dynamic dataset on a display.

9. The method of claim 8, wherein the outputting of the additional resultant dynamic dataset on the display including simultaneously displaying a plurality of interactive icons representative of the plurality of locations and graphical data representative of the first dynamic dataset, the second dynamic dataset, and the third dynamic dataset.

10. The method of claim 9, further comprising:
receiving, by the computing device, a selection of one of the plurality of interactive icons that is associated with a location of the plurality of locations; and
displaying, responsive to the selection, an information graphic including data specific to the location of the plurality of locations.

11. The method of claim 10, wherein the displaying includes simultaneously outputting the information graphic with the plurality of interactive icons representative of the plurality of locations and graphical data representative of the first dynamic dataset, the second dynamic dataset, and the third dynamic dataset.

12. A system comprising:
at least one data processor;
a displayed coupled to the at least one data processor; and
memory storing instructions which, when executed, cause the at least one data processor to perform operations comprising:
receiving a first data stream of a first data layer associated with a plurality of locations included as part of an external environment;
receiving a second data stream of a second data layer;
generating a first dynamic dataset from the first data stream as corresponding to the plurality of locations and a second dynamic dataset from the second data stream as corresponding to the plurality of locations;
generating an output corresponding to a resultant dynamic dataset that is based on the first dynamic dataset and the second dynamic dataset, the generating of the output including associating at least one value from the first dynamic dataset and at least one value from the second dynamic dataset with at least one of the plurality of locations; and
providing the output corresponding to the resultant dynamic dataset, the providing including at least one of displaying, storing, further processing, and/or transmitting.

13. The system of claim 12, wherein the first dynamic dataset is associated with at least one of the plurality of locations at a specific time.

14. The system of claim 12, wherein the operations further comprise:
receiving a third data stream of a third data layer associated with the external environment; and
generating a third dynamic dataset from the third data stream corresponding to the plurality of locations.

15. The system of claim 14, wherein the operations further comprise modifying the output corresponding to the resultant dynamic dataset, the modifying including associating at least one value of the third dynamic dataset with at least one of the plurality of locations.

16. The system of claim 12, wherein the operations further comprise:
determining that a data value from the first dynamic dataset, which is specific to a location from the plurality of locations, satisfies a condition; and
generating an alert responsive to the satisfaction of the condition.

17. The system of claim 16, wherein the operations further comprise:
transmitting the alert to at least one additional device that is external to the at least one data processor; and
enabling outputting of the alert on an additional display that is coupled to the at least one additional device.

18. The system of claim 14, wherein the operations further comprise:
determining that a data value from the first dynamic dataset, which is specific to a location from the plurality of locations, satisfies an additional condition; and
generating an alert responsive to the satisfaction of the additional condition.

19. The system of claim 18, wherein the operations further comprise:
transmitting the alert to at least one additional device that is external to the at least one data processor and a display that is communicatively coupled to the at least one data processor; and
enabling outputting of the alert on an additional display that is coupled to the at least one additional device.

20. The system of claim 19, wherein the operations further comprise:
generating an additional output corresponding to an additional resultant dynamic dataset is based on the first dynamic dataset, the second dynamic dataset, the third dynamic dataset, and the plurality of locations; and
outputting the additional output corresponding to the additional resultant dynamic dataset on a display that, the outputting including simultaneously displaying a plurality of interactive icons representative of the plurality of locations and graphical data representative of the first dynamic dataset, the second dynamic dataset, and the third dynamic dataset.
